(19) United States
(12) Patent Application Publication
(10) Pub. No.: US 2010/0243401 A1
(43) Pub. Date: Sep. 30, 2010

(54) SHIFTING ELEMENT OF A GEAR BOX

(75) Inventors: Gabor DIOSI, Friedrichshafen (DE); Christoph MARGRAF, Salem (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/719,901

(22) Filed: Mar. 9, 2010

(30) Foreign Application Priority Data
Mar. 31, 2009 (DE) 10 2009 002 038.1

(51) Int. Cl. F16D 25/06

(52) U.S. Cl. 192/85.17

(57) ABSTRACT

A shifting element of an automatic transmission with a shifting element piston that can be hydraulically actuated via an engaging pressure space and with a way of pressure compensation which compensates for dynamic engagement forces that act on the shifting element piston and are produced in the engaging pressure space filled with hydraulic liquid by its rotation. The way of pressure compensation comprising of at least one pressure compensation space that can be fed with pressure compensation liquid in which dynamic compensation forces, directed opposite to the dynamic engagement forces, can be produced by virtue of the rotation. To achieve effective passive compensation of dynamic hydraulic pressures with comparatively little radial structural space occupation, at least two pressure compensation spaces, opposite the engaging pressure space, are arranged in a cylinder space of the shifting element piston axially next to one another.

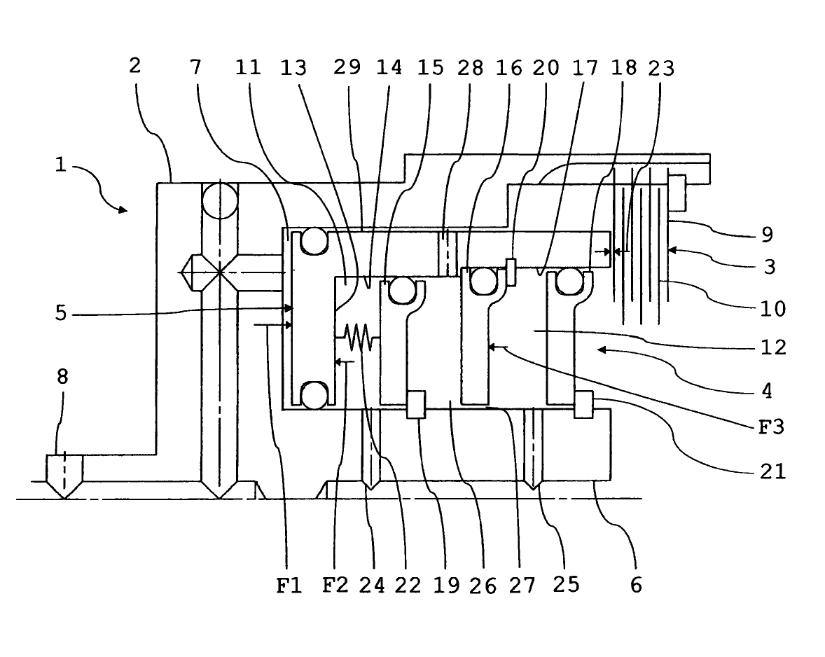

This application claims priority from German patent application serial no. 10 2009 002 038.1 filed Mar. 31, 2009.

### FIELD OF THE INVENTION

The invention concerns a hydraulically actuated shifting element, in particular of an automatic transmission.

### BACKGROUND OF THE INVENTION

For the engagement of gear steps, automatic vehicle transmissions with planetary gearsets have several, usually hydraulically actuated shifting elements in the form of gear clutches and gear brakes. In a gearshift initiated by a driving program or by a driver's wish, certain shifting elements of an engaged gear step are disengaged and other shifting elements of a gear step to be engaged are engaged, with overlap, the respective shifting elements or their control elements are actuated by an electronic transmission control unit which regulates a hydraulic system.

The hydraulic actuation of the shifting elements takes place in conventional automatic transmissions usually in the engaging direction, in such manner that a pressurized shifting element piston brings corresponding clutch or brake partners into frictional connection. In the unpressurized condition the frictional connection is disengaged, by means of restoring means, for example a restoring spring or by acting hydraulically upon the shifting element piston in the opposite direction.

The shifting element piston rotating within the transmission is usually pressurized via a pressure space that rotates with the shifting element piston, to which the pressure oil is delivered. Due to the rotation of the pressure oil, a dynamic pressure is superimposed on the static pressure. The dynamic pressure is produced because of the movement of the hydraulic fluid. Due to the centrifugal forces that occur during this, the oil in the pressure space is not uniformly distributed, and depending on the design circumstances, this in turn results in a rotational-speed-dependent axial force component which is added to the static axial force on the shifting element piston in the engaging direction. This interfering magnitude is as a rule compensated for with the help of a pressure compensation space on the rear side of the piston, in which rotating lubrication oil collects, producing a force directed in opposition to the interfering force which, in the ideal case, exactly compensates for the interfering force.

Basically, the positioning, geometry and dimensions of the pressure compensation spaces of the shifting elements are adapted to the design specifications and the existing structural situation in the transmissions. To achieve a compact form, in particular the shortest possible axial length of an automatic transmission with a relatively large number of gears, certain shifting components are often arranged radially above one another.

Such an automatic transmission is shown by US 2005/0279602 A1. In it, the disk sets of two shifting clutches are arranged one above the other. A pressure compensation space is associated with each shifting clutch. The two pressure compensation spaces have different dimensions and are also arranged radially one above the other. A common lubricant feed supplies both pressure compensation spaces, and the radially outer pressure compensation space can be filled with lubrication oil via the radially inner pressure compensation space.

Although transmission arrangements such as those mentioned by way of example have a relatively short axial length, the radial space available for the pressure compensation spaces is rather restricted. The result of this can be that due to lack of sufficiently large centrifugal forces, not enough counter-pressure can be produced in the pressure compensation spaces to compensate for the dynamic pressure produced by the rotation of the pressure space filled with pressure medium, so an undesired resultant engaging pressure component acts on the shifting element concerned. The incorporation of large enough pressure spaces seems increasingly difficult in modern transmission designs with components nested radially above one another.

In contrast, DE 101 31 816 A1 shows a transmission in which two shifting clutches are arranged next to one another. Each of the two shifting clutches comprises an engaging pressure space by which, to actuate the clutch, a respective primary piston is acted upon, which for its part actuates a secondary piston which in turn acts upon a disk set with a control force. On the rear sides of the secondary pistons extended radially outward there is arranged in each case a discharge pressure space radially above the disk set, i.e. on a larger diameter than the disk set. The discharge pressure spaces each have an oil feed through which they can be pressurized in order to move the respective shifting piston back, whereby its engaging pressure space is emptied. The discharge pressure spaces can be controlled actively as restoring means by an electro-hydraulic or electro-pneumatic pressure modulation system.

Although such relatively elaborate, active control measures are suitable for using spaces and recesses on the rear side of the piston as controllable restoring means even when the radial diameter is small, the discharge pressure spaces are rather inadequate for speed-dependent, automatic dynamic pressure compensation.

### SUMMARY OF THE INVENTION

Against this background the purpose of the present invention is to propose a hydraulically actuated shifting element, in particular for an automatic transmission, which takes up comparatively little radial structural space and yet enables effective passive compensation of dynamic hydraulic fluid pressures.

The invention is based on the finding that in the case of a hydraulically actuated shifting element of a transmission, a dynamic pressure can be compensated for with the help of a plurality of pressure compensation spaces with comparatively small radial diameter which supplement each other's action.

Accordingly the invention starts from a shifting element, in particular of an automatic transmission of a motor vehicle, with a shifting element piston actuated by an engaging pressure space and with pressure compensation means to compensate for dynamic engaging forces that act on the shifting element piston and are produced in the engaging pressure space filled with hydraulic fluid owing to its rotation, the pressure compensation means comprising of at least one compensation space that can be fed with compensation liquid, in which dynamic compensation forces directed in opposition to the dynamic engaging forces can be produced by rotation. To achieve the set objective, the invention provides at least two pressure compensation spaces that are arranged opposite the engaging pressure space, axially next to one another, in a cylinder space of the shifting element piston.

In a particularly advantageous arrangement of a shifting element according to the invention in the form of a disk clutch, the shifting element piston is arranged and can be displaced on a clutch cylinder hub, such that the first pressure compensation space is formed by a first diaphragm plate arranged fixed on the clutch cylinder hub, a piston bottom and a first radial shell surface of the clutch piston, and the second pressure compensation space is formed by a second diaphragm plate arranged fixed on the clutch cylinder hub, an annular disk arranged fixed on the piston shell, and a second radial shell surface of the clutch piston.

Each of the two pressure compensation spaces has an inlet, advantageously in the form of a radial bore in the shifting element cylinder hub, through which they can be filled with unpressurized fluid, i.e. with lubrication and cooling oil. The oil inlets can also each have a plurality of radial bores.

To ensure a venting clearance of the shift partners of the shifting element in the unpressurized condition, a restoring means advantageously in the form of a spring element can be arranged in at least one of the pressure compensation spaces. For example, a simple spiral compression spring can be supported in the first pressure compensation space between the piston bottom and the first diaphragm plate.

When the clutch cylinder rotates, an axial counter-pressure is built up in the co-operating rotating pressure compensation spaces, which opposes the dynamic engaging pressure on the shifting element piston. During this, there is advantageously an addition of the dynamic pressures on the shifting element piston, produced in the two pressure compensation spaces formed, i.e. of a size and shape designed to match the engaging pressure space so that in accordance with the relation:

\vec{F}_{dyn}_{_{—}}_{Kolben}=−(\vec{F}_{dyn}_{_{—}}_{Ausgleich}_{_{—}}₁+\vec{F}_{dyn}_{_{—}}_{Ausgleich}_{_{—}}₂)

when the forces are in equilibrium a complete dynamic pressure compensation can be achieved, with the pressure compensation spaces arranged inside the clutch cylinder space in accordance with a specified, limited available radial diameter. For example, the two pressure compensation spaces connected one after another and arranged axially next to one another replace a single pressure compensation space with a larger diameter.

Basically, even more than two pressure compensation spaces can be arranged next to one another in a shifting cylinder space. Thus, the shifting element has a flexible structural form which can be implemented relatively simply in a specified transmission concept even when the radial space is restricted, without adverse effect on the dynamic pressure compensation.

Moreover, between the pressure compensation spaces an intermediate space can be provided, via which a disk set of the shifting element can be supplied with liquid for lubrication and cooling. The supply of lubricating and cooling liquid for the disk set can be fed into the intermediate space through an annular gap between the annular disk and the cylinder hub of the shifting element, and drained away from the intermediate space toward the disk set via a lubricant outlet in the shifting element piston. A smaller part of the liquid from the second pressure compensation space is accordingly advantageously used for lubricating and cooling the clutch, whereas the main part is used as pressure compensation oil. In this way, additional lubrication oil delivery means for the disk set of the clutch can sometimes be omitted, with further space and cost advantages.

### BRIEF DESCRIPTION OF THE DRAWINGS

To clarify the invention the description of a drawing showing an example embodiment is attached. The single FIGURE in the drawing shows a longitudinal section of a shifting element of an automatic motor vehicle transmission in the form of a disk clutch I, and for simplicity, only a schematic partial section over a longitudinal axis is represented.

### DETAILED DESCRIPTION OF THE PREFERRED EMBODIMENTS

In an automatic transmission configured in this way, a plurality of disk clutches are arranged for shifting transmission ratio steps. Since the arrangement and mode of operation of shifting elements, i.e. shifting clutches and shifting brakes in automatic transmissions is known, for example from the prior art mentioned earlier, the description below is limited to the structure of the actuating device of the disk clutch 1, according to the invention.

The disk clutch 1 comprises a clutch cylinder 2, which carries the outer disks 9 of a disk set 3. Inside the clutch cylinder 2 is formed a cylinder space 4 which holds a clutch piston 5. The clutch piston 5 is arranged to move axially on a clutch cylinder hub 6 and is sealed relative to an engaging pressure space 7 positioned at its end. To actuate the clutch piston 5, the engaging pressure space 7 can be pressurized via an actuating oil delivery line 8. When so pressurized, the clutch piston 5 acts axially upon the disk set 3 so that the outer disks 9 and inner disks 10 of the latter are pushed relative to one another in the friction-locking direction and a torque can then be transmitted.

According to the invention, in the cylinder space 4 on the rear side of the piston, i.e. opposite the engaging pressure space 7, two pressure compensation spaces 11 and 12 are arranged axially next to one another. The first pressure compensation space 11, i.e. the one nearest the engaging pressure space, is delimited by a bottom 13 and a first radial shell surface 14 of the piston 5 and a first diaphragm plate 15, which is fixed on the cylinder hub 6 and seated relative to the shell surface 14 by a sealing ring (not indexed). Furthermore, in this first pressure compensation space 11 a restoring means 22 in the form of a cylindrical spiral compression spring is supported between the piston bottom 13 and the first diaphragm plate 15. The restoring spring 22 ensures that when the clutch actuating device is not pressurized, the piston 5 moves back to its rest position and consequently that there is a venting clearance 23 of the disk set 3.

The second pressure compensation space 12, i.e. the one farther away from the closing pressure space, is delimited by an annular disk 16 fixed on the piston 5 and a second radial shell surface 17 of the piston 5 and a second diaphragm plate 18, the latter being fixed on the cylinder hub 6. The annular disk 16 is fixed between a radial step of the shell surface 17 of the piston 5 and a securing ring 20 seated in a groove in the shell surface 17, and is sealed relative to the shell surface 17. The diaphragm plate 18 is held by means of a fixing ring 21 on a groove in the cylinder hub 6 and sealed relative to the shell surface 17 of the piston 5. Ordinary sealing rings (not indexed) are provided as sealing means for the piston 5, the two diaphragm plates 15, 18 and the annular disk 16. The two pressure compensation spaces 11, 12 each have a respective lubrication oil inlet 24 and 25 of their own, made as radial bores in the cylinder hub 6.

Between the two pressure spaces 11, 12 is provided an intermediate space 26 for supplying the disk set 3 with lubrication and cooling oil. The intermediate space 26 is delimited by the first diaphragm plate 15, the annular disk 16, the piston shell 29 and the cylinder hub 6. The intermediate space 26 can be filled with oil from the second pressure compensation space 12 via an annular gap 27 between the annular disk 16 and the cylinder hub 6. The lubrication and cooling oil passes from the intermediate space 26 to the disk set 3 through a lubricant outlet 28 in the form of a radial opening in the piston shell 29.

The operating mode of dynamic pressure compensation in the disk clutch 1 is as follows:

When the engaging pressure space 7 is pressurized with clutch actuation oil from the inlet 8, then by virtue of the rotation of the engaging pressure space 7 containing rotating pressure oil a dynamic axial force component F_dyn_Kolben denoted F1 in the FIGURE is produced, which acts upon the piston 5 in addition to the pressure built up in the engagement direction. In the pressure compensation spaces 11, 12 which are at least partially filled with unpressurized lubrication and cooling oil, again due to the rotation of the oil dynamic axial force components F_dyn_Ausgleich_{—}1 and F_dyn_Ausgleich_{—}2 (denoted F2 and F3 respectively in the FIGURE) are produced, which act in the opposite direction i.e. to push the piston 5 back to its non-actuated position. When force equilibrium:

\vec{F}_{dyn}_{_{—}}_{Kolben}=−(\vec{F}_{dyn}_{_{—}}_{Ausgleich}_{_{—}}₁+\vec{F}_{dyn}_{_{—}}_{Ausgleich}_{_{—}}₂)

is reached these dynamic forces exactly cancel out, so that the rotation-dependent interfering magnitude of the clutch control system is neutralized exactly in the ideal case, and in practical operation at least largely so.

### LIST OF INDEXES

1 Disk clutch
2 Shifting element cylinder, clutch cylinder
3 Disk set
4 Cylinder space
5 Shifting element piston, clutch piston
6 Shifting element cylinder hub, clutch cylinder hub
7 Engaging pressure space
8 Engaging pressure inlet
9 Outer disks
10 Inner disks
11 Pressure compensation space
12 Pressure compensation space
13 Piston bottom
14 Piston shell surface
15 Diaphragm plate
16 Annular disk
17 Piston shell surface
18 Diaphragm plate
19 Fixing ring
20 Securing ring
21 Fixing ring
22 Restoring means, restoring spring
23 Venting clearance
24 Liquid inlet
25 Liquid inlet
26 Intermediate space
27 Annular gap
28 Lubricant outlet
29 Piston shell
F1 Dynamic piston force
F2 Dynamic compensation force
F3 Dynamic compensation force

1-9. (canceled)

10. A shifting element of a motor vehicle automatic transmission, the shifting element comprising:
a shifting element piston (5) that is hydraulically actuated via an engaging pressure space (7),
with a pressure compensation means for compensating for dynamic engagement forces that act on the shifting element piston (5) and are produced in the engaging pressure space (7) filled with hydraulic liquid by rotation, the pressure compensation means comprising at least one pressure compensation space (11) that is fed with a pressure compensation liquid in which dynamic compensation forces, directed in opposition to the dynamic engagement forces, are produced by the rotation, and
at least two pressure compensation spaces (11, 12), opposite the engaging pressure space (7), being arranged axially next to one another in a cylinder space (4) of the shifting element piston (5).

11. The shifting element according to claim 10, wherein the shifting element piston (5) is arranged and movable along a shifting element cylinder hub (6), the first pressure compensation space (11) is formed by a first diaphragm plate (15) arranged on the shifting element cylinder hub (6), a piston bottom (13) and a first radial shell surface (14) of the shifting element piston (5), and
the second pressure compensation space (12) is formed by a second diaphragm plate (18) arranged on the shifting element cylinder hub (6), an annular disk (16) arranged on the piston shell (29) and a second radial shell surface (17) of the shifting element piston (5).

12. The shifting element according to claim 10, wherein the first and the second pressure compensation spaces (11, 12) each comprise a respective liquid inlet (24, 25).

13. The shifting element according to claim 12, wherein the liquid inlets (24, 25) of the first and the second pressure compensation spaces (11, 12) are radial bores formed in the shifting element cylinder hub (6).

14. The shifting element according to claim 10, wherein an intermediate space (26) is located between the first and the second pressure compensation spaces (11, 12) which facilitates the supply of lubrication and cooling liquid to a disk packet (3).

15. The shifting element according to claim 14, wherein the liquid for lubricating and cooling the disk packet (3) passes through an annular gap (27), formed between the annular disk (16) and the shifting element cylinder hub (6), into the intermediate space (26) and the liquid then flows from the intermediate space (26), toward the disk packet (3), via a lubricant outlet (28) in a piston shell (29).

16. The shifting element according to claim 11, wherein a restoring means (22) is arranged in at least one of the first and the second pressure compensation spaces (11, 12).

17. The shifting element according to claim 16, wherein the restoring means (22) is a spiral compression spring which is supported in the first pressure compensation space (11) between the piston bottom (13) and the first diaphragm plate (15).

18. The shifting element according to claim 10, wherein at least one of spatial extensions and shapes of the engaging pressure space (7) and the first and the second pressure compensation spaces (11, 12) are matched with one another such that dynamic hydraulic forces (F2, F3), acting on the two sides of the shifting element piston (5), are at least approximately equal.
